(19) United States
(12) Patent Application Publication
(10) Pub. No.: US 2006/0117113 A1
(43) Pub. Date: Jun. 1, 2006

(54) Rapidly deployable ad hoc network

(76) Inventors: Brig Barnum Elliott, Arlington, MA (US); Jerry D. Burchfiel, Waltham, MA (US); Anthony Michel, Lexington, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 10/147,158

(22) Filed: May 16, 2002

(51) Int. Cl. G06F 15/173

(52) U.S. Cl. 709/239

(57) ABSTRACT

The present invention shows, among other things, how to build rapidly deployable ad hoc networks from a combination of wired communications components with wireless communication components. The resulting kind of network is entirely novel and has a number of advantages over existing wireless-only techniques. Namely, it combines automatic robustness in the face of errors and network destruction with the high speed and great resistance to jamming of wired network.

### DESCRIPTION OF THE INVENTION

1. Field of the Invention

The present invention relates to methods and systems for facilitating rapid deployment of ad hoc networks.

2. Description of Related Art

Certain situations, such as military battlefields or scenes of disaster relief, require rapid deployment of communication networks. Rapidly deployed communication networks are referred to as “ad hoc networks” because they do not rely on a pre-established infrastructure. Each user participating in an ad hoc network forward data packets as needed to ensure that the packets are delivered from a source to a destination in the network.

Ad hoc networks have generally relied entirely upon wireless networks because wireless elements in the wireless network may be easily emplaced. However, wireless networks usually have low throughput and are susceptible to jamming and accidental interference. In contrast, wired networks have high throughput and great resistance to jamming because they confine signals within a waveguide, such as fiber optic strands or metallic wires. However such wired networks can not be rapidly deployed in an ad hoc manner in redundant meshes. Hence a form of ad hoc networking that could self-organize, route around failures, and employ both wired and wireless links would be advantageous.

### SUMMARY OF THE INVENTION

Systems and methods consistent with the present invention provide for the creation of ad hoc networks by combining wireless elements and wired elements. Both elements may be rapidly deployed using unconventional means, such as missiles and helicopters, or more conventional means, such as trucks. The invention combines advantages of wireless networks, such as flexibility, rapid deployment and robustness in the face of errors and network destruction, with the high speed and great resistance to jamming of wired networks.

One exemplary aspect of the present invention may be a rapidly deployable ad-hoc network. The network may include a first transceiver, a second transceiver connected to the first transceiver by a wired link to facilitate communication between the first transceiver and the second transceiver when necessary, and a wireless link established when necessary to facilitate communication between the first transceiver and the second transceiver. A routing protocol may dynamically determine a path selected from the wired link and the wireless link to communicate packets between the first transceiver and the second transceiver adjusting accordingly based on an available quality of service using at least one of the wired link and the wireless link.

A second exemplary aspect of the present invention may be a rapidly deploying ad-hoc network. The network may include a plurality of transceivers, a plurality of wired links connecting some of the transceivers to facilitate communication between the connected transceivers and a plurality of wireless links, each wireless link established when necessary to facilitate communication between selected transceivers. A routing protocol may dynamically determine a path selected from the wired and the wireless links to communicate packets between transceivers adjusting accordingly based on a quality of service using the wired links and the wireless links.

A third exemplary aspect of the present invention may be a method for communicating packets in a rapidly deployed ad-hoc network. The method may include providing a wired link to facilitate communication between a first transceiver and a second transceiver when necessary and providing a wireless link when necessary to facilitate communication between the first transceiver and the second transceiver. A routing protocol may dynamically determine a path selected from the wired link and the wireless link to communicate packets between the first transceiver and the second transceiver adjusting accordingly based on a quality of service using at least one of the wired link and the wireless link.

A fourth exemplary aspect of the present invention may be a method of communicating packets in a rapidly deployed ad-hoc network. The method may include providing a plurality of wired links to facilitate communication between a set of transceivers selected from a plurality of transceivers when necessary and providing a plurality of wireless links when necessary to facilitate communication between selected transceivers. The routing protocol may dynamically determine a path selected from the wired and wireless links to communicate packets between transceivers adjusting accordingly based on any disruptions in communication using wired and wireless links.

A fifth exemplary aspect of the present invention may be a device for use in an ad-hoc network. The device may include a processor, memory, means for facilitating communication using at least one wired link when necessary, and means for facilitating communication using at least one wireless link when necessary. A routing protocol may dynamically determine a path including at least one of the wired link and the wireless link to communicate packets adjusting accordingly based on a quality of service using at least one of the wired link and the wireless link.

A sixth exemplary aspect of the invention may include a system. The system may include a means for specifying a missile destination and a means for launching a missile traveling substantially toward the missile destination. The missile may be connected to a wired link and communication between devices may be facilitated via the wired link after the missile and a transceiver connected to the wired link has been launched.

Additional aspects of the invention are set forth in the description which follow, and in part are obvious from the description, or may be learned by practice of methods, systems, and articles of manufacturer consistent with features of the present invention. The aspects of the invention may be realized and attained by means of the elements and combinations particularly pointed out in the appended claims. It is understood that both the foregoing description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings,

FIG. 1 illustrates a first exemplary form of building blocks for an ad hoc network in which methods and systems consistent with features and principles of the present invention may be implemented;

FIG. 2 illustrates an exemplary means for deploying a network consistent with features and principles of the present invention;

FIG. 3 illustrates a first exemplary ad hoc network in which methods and systems consistent with features and principles of the present invention may be implemented;

FIG. 4 illustrates an abstract network graph of the first exemplary ad hoc network consistent with features and principles of the present invention;

FIG. 5 illustrates a second exemplary form of building blocks for an ad hoc network in which methods and systems consistent with features and principles of the present invention may be implemented;

FIG. 6 illustrates an abstract network graph of a second exemplary ad hoc network consistent with the features and principles of the present invention;

FIG. 7 illustrates the second exemplary ad hoc network in which methods and systems consistent with features and principles of the present invention may be implemented;

FIG. 8 illustrates an exemplary environment in which second form building blocks may exploit rich connectivity for network robustness consistent with features and principles of the present invention;

FIG. 9 illustrates an exemplary environment in which an ad hoc network exploits rich connectivity for network robustness consistent with features and principles of the present invention;

FIG. 10A illustrates an exemplary hardware schematic of wireless transceivers consistent with features and principles of the present invention; and

FIG. 10B illustrates another exemplary hardware schematic of wireless transceivers consistent with features and principles of the present invention.

### DETAILED DESCRIPTION

Systems and methods consistent with the present invention provide for the creation of ad hoc networks by combining wireless elements and wired elements. The wireless and wired elements are self-organized to facilitate communication between devices over the ad hoc network. Self-organization involves the use of routing protocols that determine network paths for the communication. Self-organizing networks do not require substantial external organization such as those provided by pre-existing infrastructure in determining the network paths. Rather, ad hoc networks may be rapidly deployed without substantial regard to pre-existing infrastructure. The ad hoc networks may further configure themselves to route around disruptions or unacceptable quality in communication using both the wireless and wired elements.

Reference is now made in detail to exemplary embodiments of the invention, examples of which are illustrated in the accompanying drawings. Wherever possible, the same reference numbers are used throughout the drawings to refer to the same or like parts.

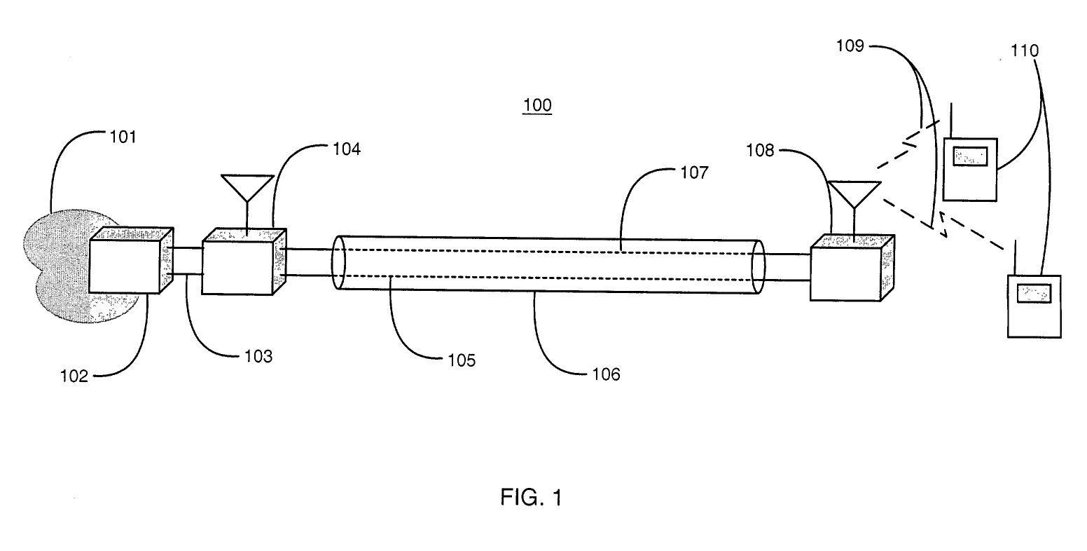

FIG. 1 illustrates a first exemplary form of the basic building blocks for an ad hoc network 100 in which methods and systems consistent with features and principles of the present invention may be implemented. FIG. 1 includes an external network 101, an external router 102, an external wire 103, a wireless transceiver 104, a first fiber-optic strand 105, a fiber-optic cable 106, a second fiber-optic strand 107, a second wireless transceiver 108, two wireless communication links 109, and two wireless devices 110. External wire 103 may physically and communicably link the external router 102 and the wireless transceiver 104 to form a wired communication link. Wireless devices 110 and the second wireless transceiver 108 may be communicably linked by the wireless communication links 109. Wireless communication links may include a radio frequency link, infrared link, acoustic link, or any other communication link without wires. Fiber-optic cable 106 may form another wired communication link between the wireless transceivers 104 and 108. Wireless transceivers 104 and 108 may contain routers (not shown). The routers may act as network bridges for the wireless transceivers 104 and 108 and the fiber-optic cable 106.

Fiber-optic cable 106 may contain two wires, fiber-optic strands 105 and 107. One fiber-optic strand may be used for communication in one direction, and the other fiber-optic strand may be used for communication in the opposite direction. In an alternative configuration (not shown) a single fiber-optic or other physical communication link strand may be used for round-trip communication between the transceivers.

The routers in the wireless transceivers 104 and 108 at each end of the fiber-optic cable 106 may contain an optical transmitter (not shown) attached to one fiber-optic strand and an optical receiver (not shown) attached to the other fiber-optic strand. Thus when one router transmits over the fiber-optic cable 106, the other router may receive over the fiber-optic cable 106. Commercial examples in the art illustrating simultaneous transmission and reception may include fiber-optic telephony networks.

Each wireless transceiver 104 and 108 also may contain its own self-contained power supply such as a fuel cell, battery, solar power converter, etc. (not shown). A number of such wireless transceivers 104 and 108 and fiber cables 106 may be deployed in order to form an ad hoc network for a region.

The use of the fiber-optic cable 106 in the building block 100 is exemplary and does not preclude the use of other wire medium, such as metal wire, to create physical communication links between wireless transceivers 104 and 108.

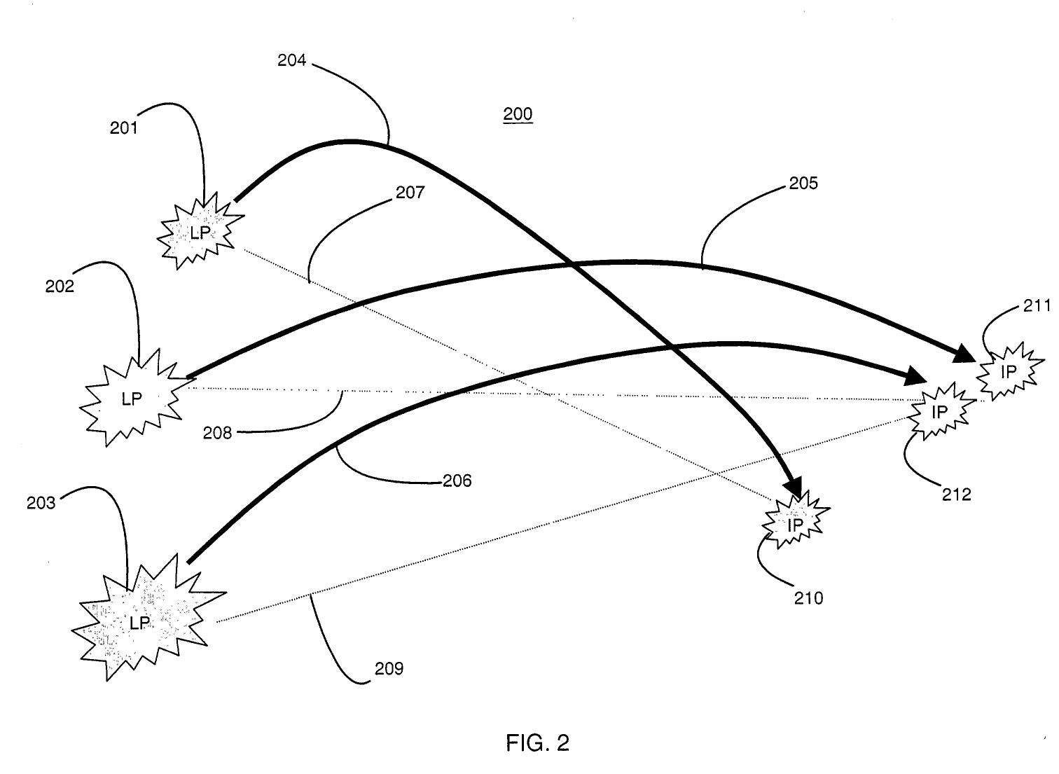

FIG. 2 illustrates an exemplary means for deploying a network 200 consistent with features and principles of the present invention. FIG. 2 includes three launching points (LP) 201-203, three trajectories 204-206, three fiber-optic cables 207-209, and three impact points (IP) 210-212. Missiles or other similar devices (not shown) may be fired from the launching points 201-203. The missiles travel along their respective missile trajectories 204-206 to land at their respective impact points 210-212. As the missiles move along their missile trajectories 204-206, they may deploy fiber-optic cables 207-209. Wireless transceivers may be attached at the ends of the fiber-optic cables 207-209 after the missiles land at their impact zones 210-212 to form an ad hoc network. The wireless transceivers may also be pre-attached to the fiber-optic cables 207-209 and deployed by the missiles.

Examples of situations where fiber-optic cables may be attached to missiles exist and include Tube-launched, Optically-tracked, and Wire-guided (TOW) anti-tank missiles. A TOW missile requires a gunner to spot such as an enemy tank through a sight. The gunner may fire the missile from a tube similar to a bazooka. A pair of thin wires may be connected to the rear of the missile and spool out from the launching tube. These wires may be used to send signals to control the missile's fins and thus direction of flight. However, the wires are not used to form a network.

Further exemplary means of rapidly deploying wiring may include deploying wire from air-based, sea-based, land-based, and space-based vehicles, trucks, submarines, planes, satellites, and helicopters as they maneuver over a region and/or by human hand. Rapid deployment may include laying wire without regard to obstacles or intent to use existing infrastructure. Means of deploying wire may simply lay down the wire across a landscape. The wire may lie across ditches, over bushes, or hang from buildings and trees along its path.

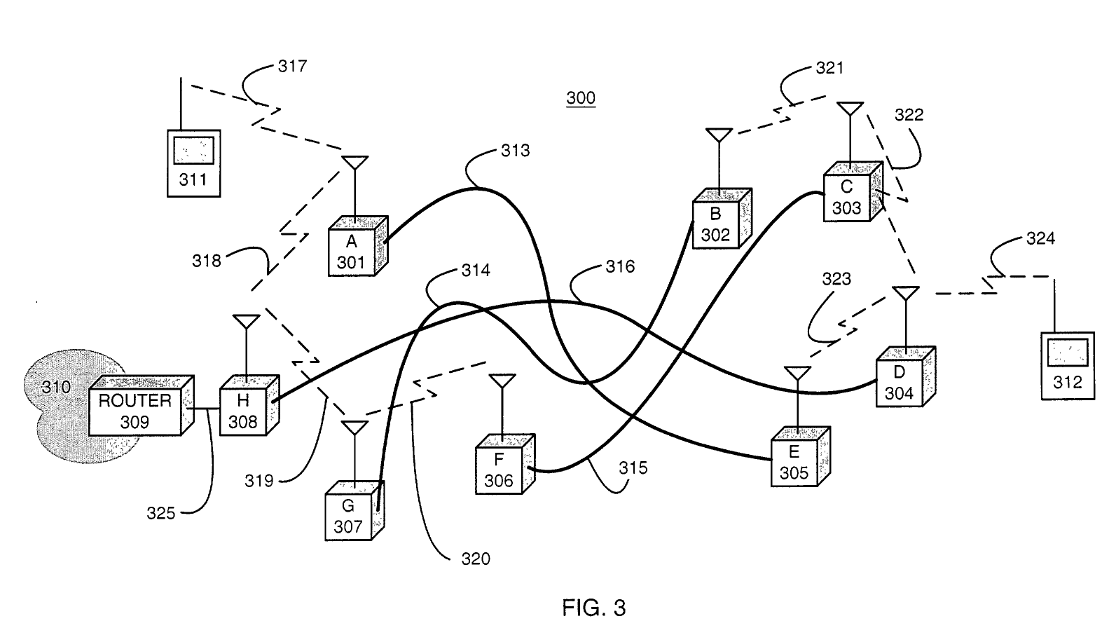

FIG. 3 illustrates how a number of deployed wires 313-316 may be organized into a first exemplary ad hoc network 300 in which methods and systems consistent with features and principles of the present invention may be implemented. As shown in FIG. 3, the exemplary ad hoc network 300 may be formed by a number of simple form ad hoc networks like the one illustrated in FIG. 1. The ad hoc network 300 may include eight wireless transceivers 301-308, an external router 309, an external network 310, two wireless devices 311-312, four deployed wires 313-316, wireless communication links 318-323, and wireless device communication links 317 and 324. The wireless transceivers 301-304 may have wired communication links over the wires 313-316 to the wireless transceivers 305, 307, 306, and 308, respectively. The first wireless device 311 may be communicably linked with transceiver A 301 by the wireless device communication link 317. Transceiver A 301 may be communicably linked with transceiver H 308 by the wireless communication link 318. Transceiver G 307 may be communicably linked with transceivers H 308 and F 306 by wireless communication links 319-320, respectively. Transceiver B 302 may be communicably linked with transceiver C 303 by the wireless communication link 321. Transceiver D 304 may be communicably linked with transceiver C 303 and E 305 by wireless communication links 322 and 323, respectively. The second wireless device 312 may be communicably linked with transceiver D 304 by the wireless device communication link 324.

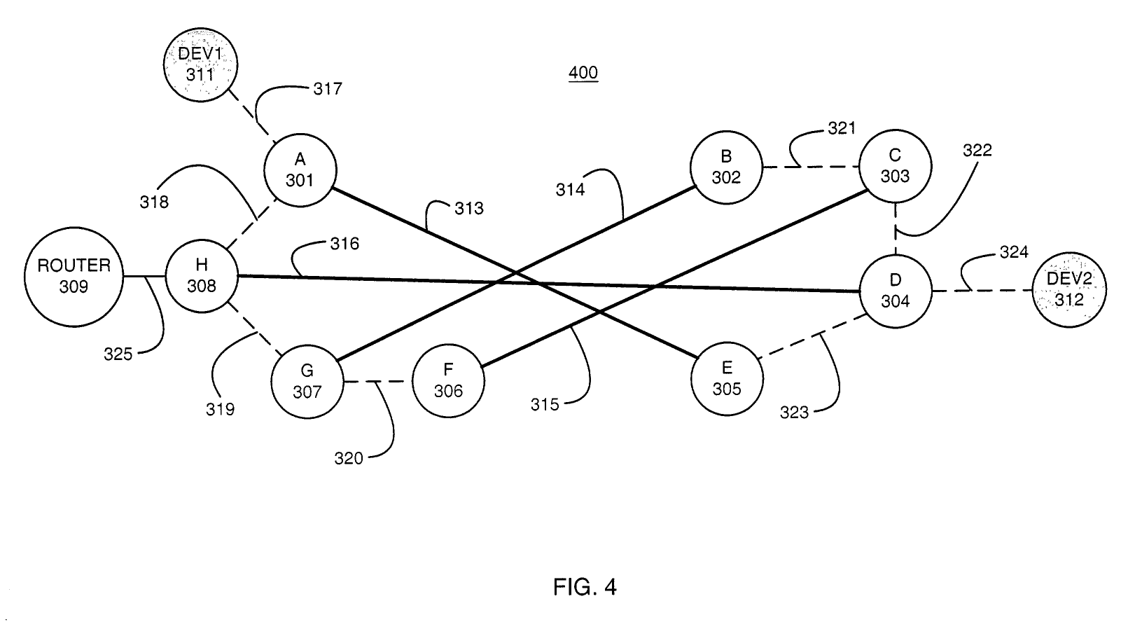

FIG. 4 illustrates the corresponding abstract network graph 400 for the exemplary ad hoc network 300 in FIG. 3. In the network graph 400, the solid lines indicate wired communication links 313-316 and 325, and the dashed lines 317-324 indicate wireless or wireless device communication links. In essence, the set of wireless transceivers 301-308 may form an ad hoc network for communication between the devices 311-312 that access the ad hoc network via wireless device communication links 317 and 324. When the two devices 311-312 communicate, a network path may be formed. A network path may be a combination of wireless and/or wired communications links in the ad hoc network that communicably links the two devices. For example, a network path comprising wireless device communication link 317, wired communication link 313, wireless communication link 323, and wireless device communication link 324 may be used by the devices 311 and 312 to communicate with each other.

The exemplary ad hoc network 300 may run under the Internet Protocol (IP) suite, but it may also run under an Asynchronous Transmission Mode (ATM) network protocol or any form of network protocol. Network paths through this network may be self-organized and computed by a routing protocol such as Link-State Routing (also called Shortest Path First), distance vector routing, Mobile Ad-Hoc Network (MANET) routing (such as Ad-Hoc On-Demand Distance Vector (AODV) or Dynamic Source Routing (DSR)), or any other routing protocol. Since the network graph 400 resembles that of many other forms of networks known in the art, all kinds of routing technology may be employed.

For example, the exemplary ad hoc network 300 in FIG. 3 may be running a Shortest Path First (SPF) routing protocol. Wireless device 311 may seek to communicate with wireless device 312 in FIG. 3. Under the SPF routing protocol, the ad hoc network 300 self-organizes to facilitate communication between the wireless devices 311-312 by dynamically determining a shortest network path consisting of wired and wireless communication links. The SPF routing protocol may organize a shortest network path comprising the wireless device communication link 317, the wired communication link 316, the wireless communication link 323, and the wireless device communication link 324. However, if the quality of communication over the network path is unacceptable, then the routing protocol may organize the next shortest network path. The next shortest network path may have more acceptable quality of communication and may comprise of the wireless device communication links 317 and 324, the wireless communication links 318-320 and 322, and the wired communication link 315.

In the above example, self-organization includes the control and determination of network paths without substantial external organization such as those provided by pre-existing infrastructure. The ad hoc network 300 controls and determines the paths and alternative paths as dictated by the routing protocols to provide acceptable quality of communication. Control over the network paths may reside in one component of the ad hoc network 300 or it may be distributed over all the components of the ad hoc network 300. One of the transceivers 301-308 may be a master node and coordinate all the networks paths or some of the transceivers may co-operatively determine the network paths.

In many ways, the wire communication links 313-316 are vastly superior to the wireless communication links 318-323. They are much faster, resistant to jamming, and generally require less power. Thus these wired communication links 313-316 may be preferred over the wireless communication links 318-323 when forming a network path. This preference may be accommodated in most routing protocols by setting link metrics in the routing protocols accordingly. For example, wire communication links 313-316 may be assigned very low link metrics and wireless communication links 318-323 may be assigned very high link metrics. Therefore, a resistance of network paths that use wireless communication links may be much higher than those that use wired communication links. The protocol may choose the network path of least resistance. The chosen network path across the ad hoc network may consist of many different transitions from wireless to wired communication links and vice versa. The exemplary ad hoc network 300 in FIG. 3 may handle many deployment scenarios. However some scenarios may require more wireless transceivers. For example, in the event that wires break or a great deal of terrain needs to be covered and the wired transceivers do not lie within wireless range of each other, additional wireless transceivers may be needed to bridge the break or cover the terrain. Therefore, another exemplary form of the invention may include a series of wireless transceivers along the length of the fiber cable.

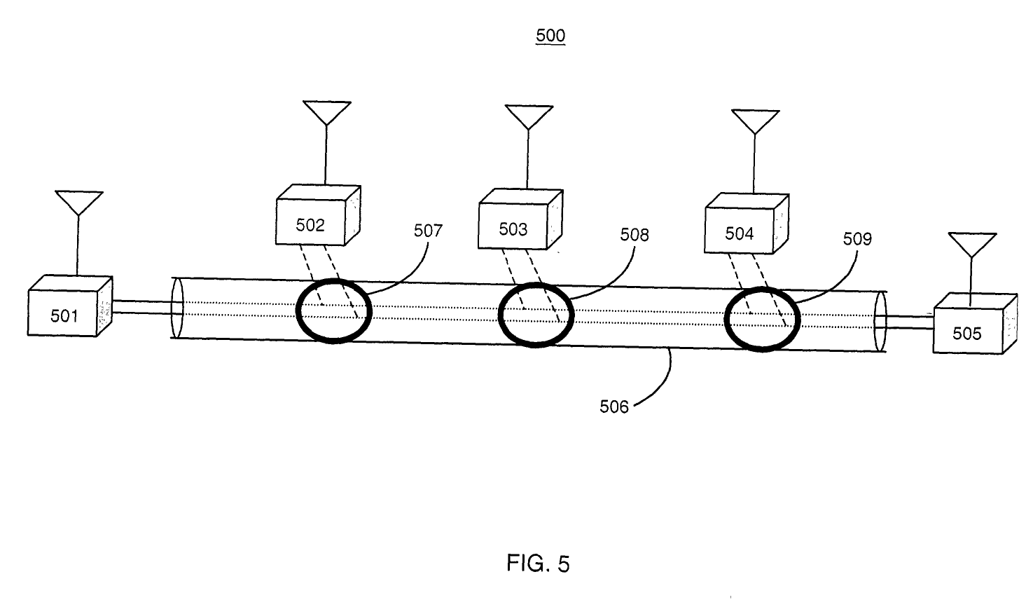

FIG. 5 illustrates a second exemplary form of building blocks for an ad hoc network 500 in which methods and systems consistent with features and principles of the present invention may be implemented. As shown, FIG. 5 includes five wireless transceivers 501-505, a wire cable 506 with two strands, and three tap connections 507-509. The intermediate wireless transceivers 502-504 may create a daisy chain along the wire cable 506 connecting the first and last wireless transceivers 501 and 505. The first wireless transceiver 501 may communicate directly with the next wireless transceiver 502, which in turn may communicate with the next wireless transceiver 503, and may continue so forth to the last wireless transceiver 505. When all wireless transceivers 501-505 have power, a packet (not shown) may proceed along the wire cable 506, hop by hop, retransmitted by each wireless transceiver. The packet may be information represented in a form communicable over the wire cable 506 and wireless transceivers 501-505. This daisy chain form of building block 500 may require each wireless transceiver 501-505 to receive and retransmit the packet to the next wireless transceiver 501-505. If one of the wireless transceivers 501-505 in the daisy chain is not operational, then the packet may not be communicated passed the non-operational wireless transceiver.

An alternate embodiment may employ Passive Optical Networking (PON) versus retransmitting by each wireless transceiver. In PON, the wire cable 506 may be a fiber-optic cable and the wireless transceivers 502-504 in the middle may tap into the fiber-optic cable using passive techniques. The various wireless transceivers 501-505 may employ channel access arbitration to decide when and which wireless transceiver 501-505 transmits a packet and use channel-level addressing to determine which wireless transceiver 501-505 receives any transmitted packets on the wire cable 506. The alternate embodiment may not require the wireless transceivers 501-505 to always retransmit the packet.

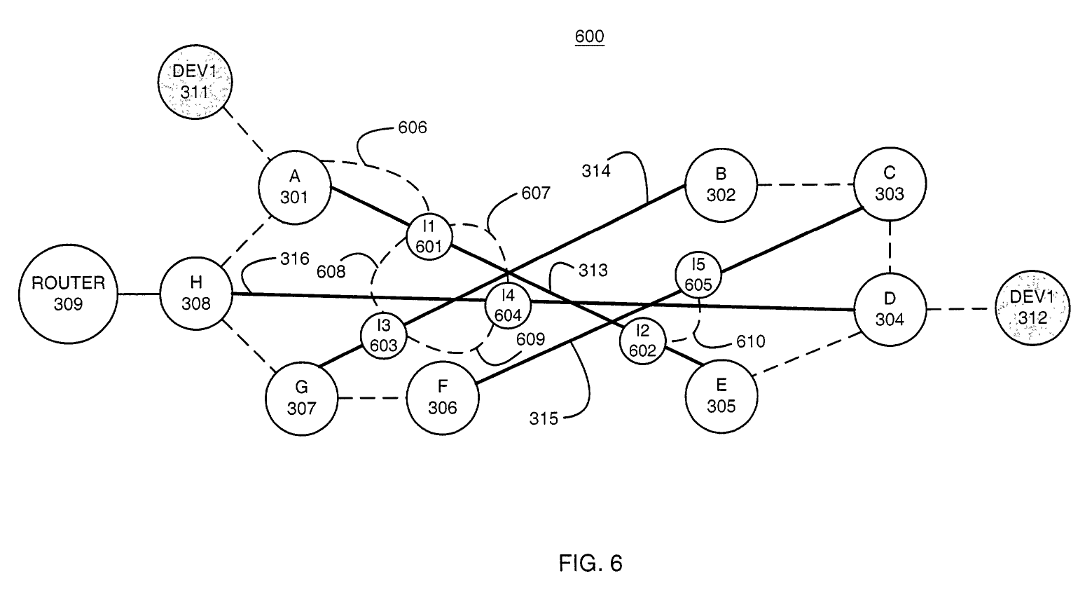

FIG. 6 illustrates an abstract network graph 600 of a second exemplary ad hoc network consistent with the features and principles of the present invention. In addition to the elements illustrated in FIG. 4, FIG. 6 includes five intermediate wireless transceivers 601-605 and five more wireless connections 606-610. The first two intermediate transceivers I1 601 and I2 602 may be situated along the wire cable 313 connecting transceiver A 301 and transceiver E 305. The third intermediate transceiver I3 603 may be situated along the wire cable 314 connecting transceiver G 307 and transceiver B 302. The fourth intermediate transceiver I4 604 may be situated along the wire cable 316 between transceivers H 308 and D 304. The fifth intermediate transceiver I5 605 may be situated along the wire cable 315 between transceivers F 306 and C 303.

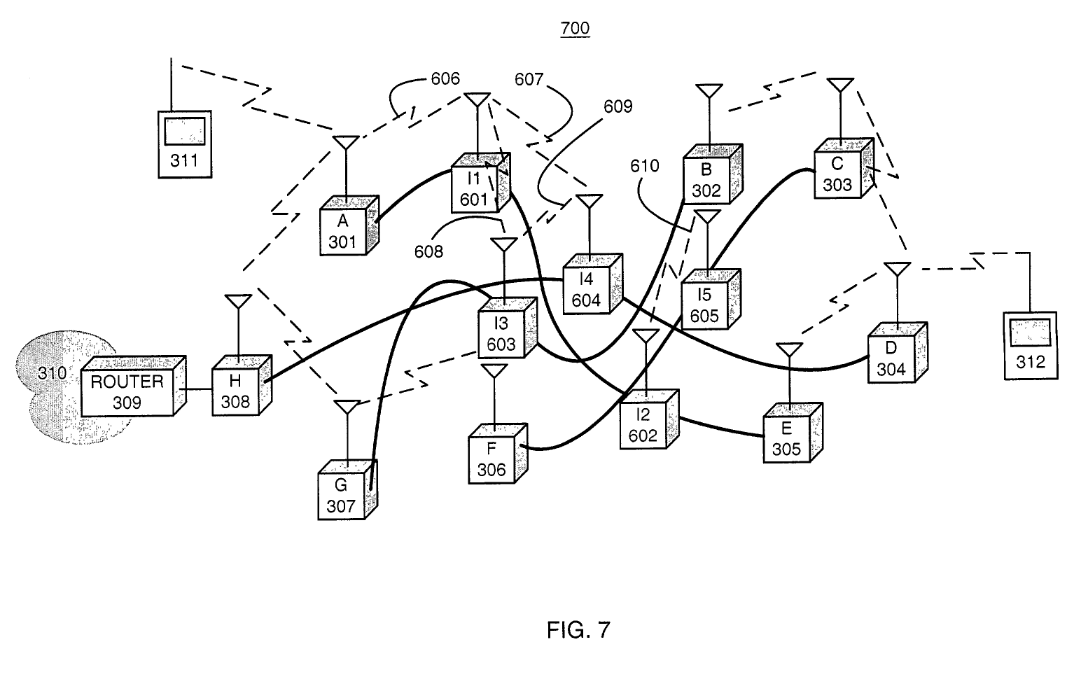

FIG. 7 illustrates the second exemplary ad hoc network 700 corresponding to the abstract network diagram 600 in which methods and systems consistent with features and principles of the present invention may be implemented. The intermediate wireless transceivers 601-605 may increase the richness of connectivity in the ad hoc network 700 with the addition of wireless communication links 606-610. Richness in connectivity may be the total number of wired and wireless communication links. Higher richness in connectivity may allow the ad hoc network 700 in FIG. 7 to have more potential network paths than the ad hoc network 300 in FIG. 3.

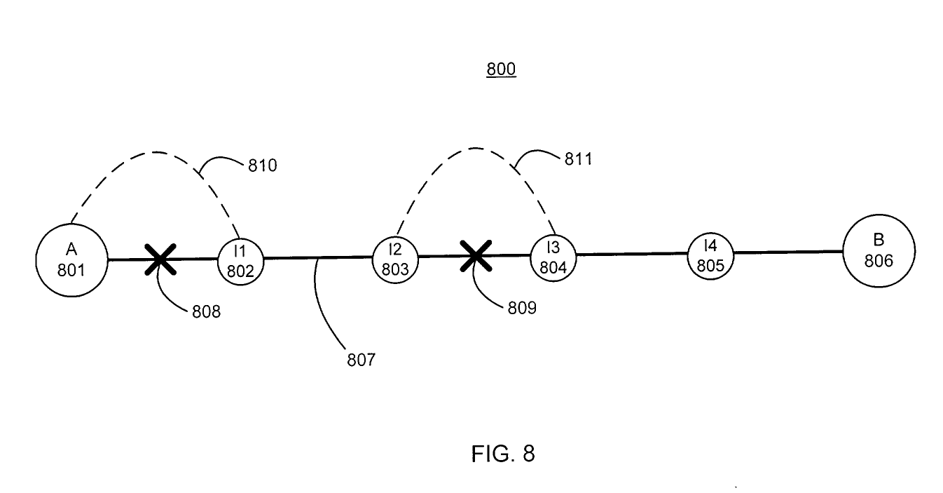

FIG. 8 illustrates an exemplary environment in which a building block 800 may exploit rich connectivity for network robustness consistent with features and principles of the present invention. Block 800 may include two wireless transceivers 801 and 806, four intermediate wireless transceivers 802-805, a wire cable 807, two wireless communication links 810 and 811, and two breaks 808 and 809 in the wire cable 807. The wire cable 807 may form a wired communication link between the wireless transceivers 801 and 806. The intermediate wireless transceivers 802-805 may tap into the wire cable 807 using passive techniques. The breaks 808 and 809 in the wire cable 807 may prevent wireless transceivers 801 and 806 from communicating through a network path consisting only of the wire communication link over the wired cable 807. However, the rich connectivity created by the intermediate wireless transceiver 802-804 may allow communication between the wireless transceivers 801 and 806 using an alternate network path including the wireless communication links 810 and 811 and wired communication links over portions of the wired cable 807 to circumvent the breaks 808 and 809.

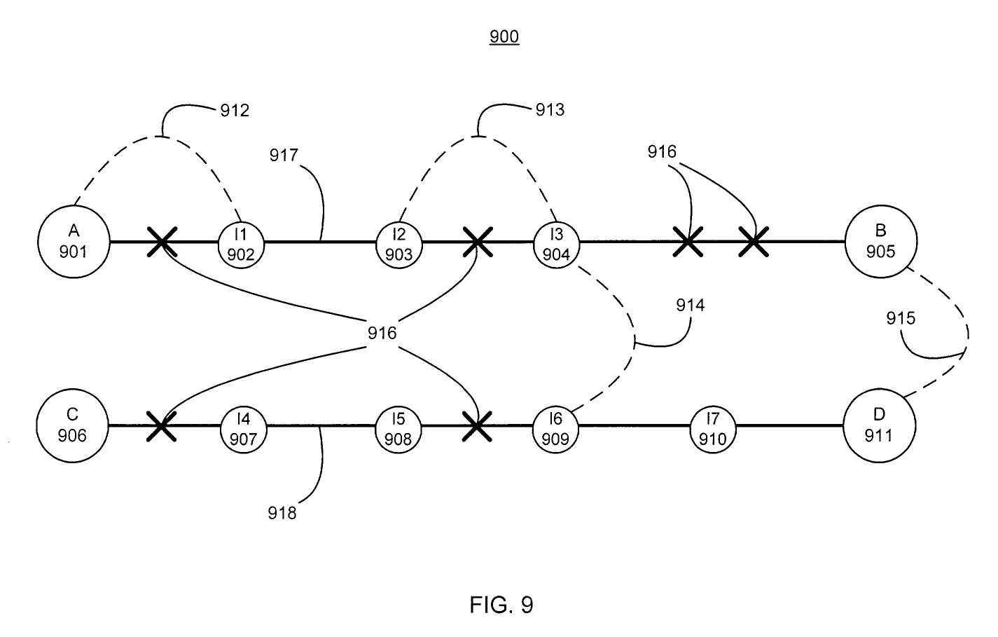

FIG. 9 illustrates an exemplary environment in which an ad hoc network 900 may exploit rich connectivity for highly robust connectivity consistent with features and principles of the present invention. The ad hoc network 900 may include four wireless transceivers 901, 905, 906, and 911, seven intermediate wireless transceivers 902-904 and 907-910, two wire cables 917 and 918, breaks 916 in the wireless cables 917 and 918, and four wireless communication links 912-915. The breaks 916 may prevent wireless transceiver A 901 from communicating with wireless transceiver B using a network path comprising of only a wired communication link over the wired cable 917. However, another network path comprising of the wireless communication links 912-915 and wired communication links over portions of the wired cables 917 and 918 without breaks 916 may allow the wireless transceivers 901 and 905 to communicate.

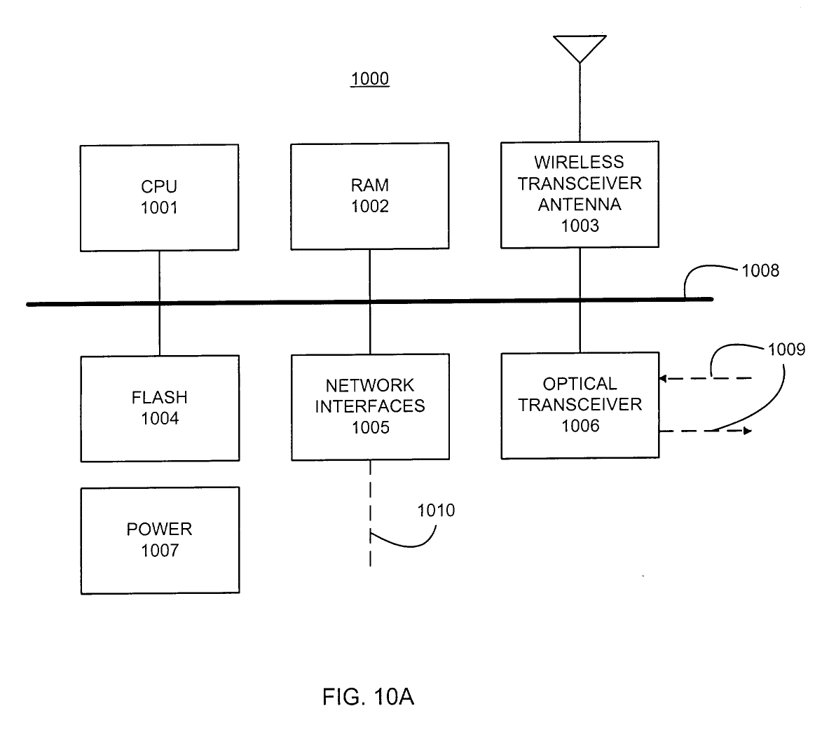

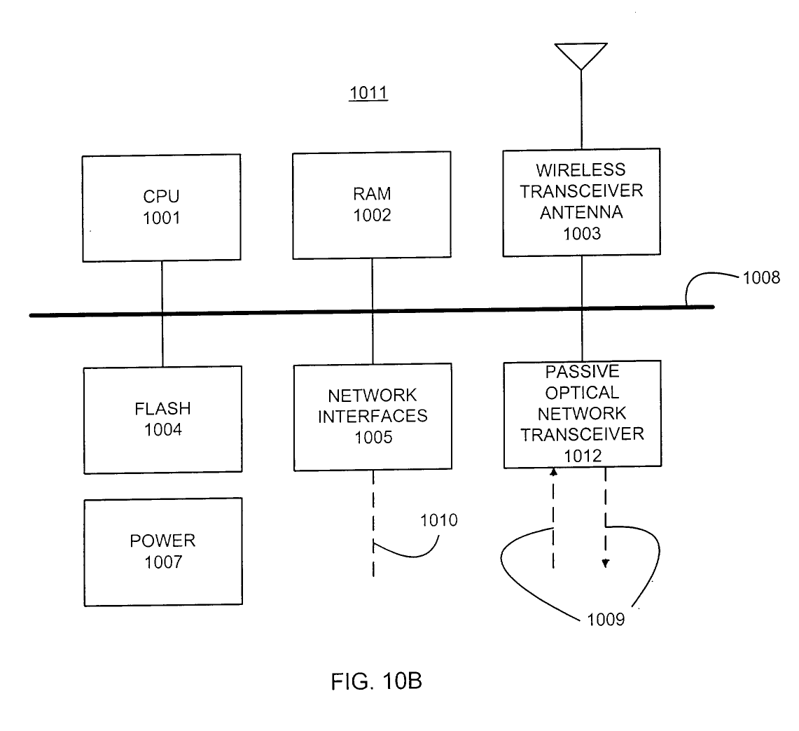

FIG. 10A illustrates an exemplary hardware schematic 1000 of a wireless transceiver consistent with features and principles of the present invention. The schematic 1000 may be suitable for wireless transceivers attached at ends of fiber-optic cables or for intermediate wireless transceivers that may be daisy chained as illustrated in FIG. 5. The schematic 1000 may include central processing unit (CPU) 1001, random-access memory (RAM) 1002, wireless transceiver antenna 1003, flash memory 1004, network interfaces 1005, optical transceiver 1006, power supply 1007, bus 1008, fiber-optic strands 1009, and external network connection 1010. The CPU 1001, RAM 1002, wireless transceiver antenna 1003, flash memory 1004, network interfaces 1005, and optical transceiver 1006 may communicate using the bus 1008. The power supply 1007 may provide energy for the components 1001-1006 to perform their functions. The optical transceiver 1006 may transmit and receive packets of information over the fiber-optic strands 1009.

Wireless and intermediate wireless transceiver may contain one or more network interfaces 1005 for a wired communication link over an external network connection 1010 to an external network (not shown). Some exemplary network interfaces may be Ethernet transceivers, Asynchronous Transfer Mode (ATM) transceivers, serial lines, or any other conventional means known in the art. The network interface 1005 may also be used to connect two wireless transceivers, thus forming a wired communication link between the two wireless transceivers.

FIG. 10B illustrates another exemplary hardware schematic 1011 of wireless transceivers consistent with features and principles of the present invention. The schematic 1011 in FIG. 10B is the same as the schematic 1000 in FIG. 10A with one exception. The exception is that in place of the optical transceiver 1006 in FIG. 10A, the schematic 1011 in FIG. 10B may have a passive optical network transceiver 1012. This schematic 1011 may be suitable for use in an ad hoc network employing PON as described above.

In the foregoing description, various features are grouped together in various embodiments for purposes of streamlining the disclosure. This method of disclosure is not to be interpreted as reflecting an intention that the claimed invention requires more features than are expressly recited in each claim. Rather, as the following claims reflect, inventive aspects may lie in less than all features of a single foregoing disclosed embodiment. Thus, the following claims are hereby incorporated into this description, with each claim standing on its own as a separate embodiment of the invention.

1. (canceled)

2. The system of claim 12, wherein the plurality of wired links includes at least one of fiber optic wire and metallic wire.

3. The system of claim 12, wherein the wireless links includes at least one of radio frequency links, infrared links, and acoustic links.

4. The system of claim 12, wherein the router uses at least one of Shortest-path First, Distance Vector, and Mobile Ad Hoc Networking protocols.

5. The system of claim 12, wherein the plurality of wired links is are deployed by a rapid deployment vehicle.

6. The system of claim 5, wherein the rapid deployment vehicle is at least one of air-based, land-based, sea-based, and space-based vehicles.

7. The system of claim 5, wherein the rapid deployment vehicle is at least one of, a helicopter, missile, plane, submarine, boat and automobile.

8. The system of claim 12, wherein the system supports at least one network protocol.

9. The system of claim 12, wherein the network protocol is at least one of Internet Protocol suite, Asynchronous Transfer Mode, Multi-Protocol label switching, and Ethernet 802.2 bridging.

10. The system of claim 12, wherein a path to communicate packets between the first transceiver and the second transceiver is initially selected from the wired link and the wireless link based on a quality of the communication using at least one of the wired link and the wireless link.

11. The system of claim 12, wherein the routing protocol adjusts the path accordingly using at least one of the wired and the wireless links when there is a disruption in communication.

12. A system comprising:
a rapidly deployable network, configured for deployment from a moving vehicle, including
a plurality of wired links connecting some of a plurality of transceivers to facilitate communication between the transceivers connected by the wired links, wherein the plurality of transceivers are configured for wireless communication
to facilitate communication, via wireless links, between transceivers connected to different ones of the plurality of wired links; and
a router configured to dynamically determines a path selected from the wired links and the wireless links to communicate packets between transceivers connected to different ones of the plurality of wired links.

13. A method for communicating packets comprising:
deploying a rapidly deployable network including a plurality of transceivers by:
providing a first wired link between a first transceiver of the plurality of transceivers and a second transceiver of the plurality of transceivers;
providing a wireless link between the second transceiver of the plurality of transceivers and a third transceiver of the plurality of transceivers connected to a second wired link at a first location on the second wired link to facilitate communication between the first transceiver of the plurality of transceivers and a fourth transceiver of the plurality of transceivers connected to the second wired link at a second location on the second wired link, and
employing a routing protocol to dynamically determines a path through the rapidly deployable network to communicate packets among the plurality of transceivers.

14. The method of claim 13, wherein the first and second wired links comprise at least one of fiber optic wire and metallic wire.

15. The method of claim 13, wherein the wireless link includes at least one of radio frequency link, infrared link, and acoustic link.

16. The method of claim 13, wherein the routing protocol uses at least one of Shortest-path First, Distance Vector, and Mobile Ad Hoc Networking protocols.

17. The method of claim 13, wherein deploying the rapidly deployable network comprises deploying the wired link by a vehicle.

18. The method of claim 17, wherein vehicle is one of an air-based, land-based, sea-based, and space-based vehicles.

19. The method of claim 17, wherein the vehicle is of a helicopter, missile, plane, submarine, boat and automobile.

20. The method of claim 13, wherein the rapidly deployable network supports at least one network protocol.

21. The method of claim 20, wherein the network protocol is at least one of Internet Protocol suite, Asynchronous Transfer Mode, Multi-Protocol label switching, and Ethernet 802.2 bridging.

22. The method of claim 13, wherein the path is selected from the wired link and the wireless link based on the quality of a communication using at least one of the wired link and the wireless link.

23. The method of claim 13, wherein the routing protocol adjusts the path accordingly using at least one of the wired and the wireless links when there is a disruption in communication.

24-26. (canceled)

27. A system comprising:
means for specifying a missile destination; and
means for launching a missile traveling substantially toward the missile destination,
wherein the missile is connected to a wired link and communication between devices is facilitated via the wired link after the missile and a transceiver connected to the wired link has been launched.

28. The system of claim 27, further includes:
a plurality of transceivers,
wherein at least two transceivers are connected to the wired link and communication between devices is facilitated via at least one of the wired link and the transceivers.

29. The system of claim 27, wherein quality in communications are adjusted via at least one of the wired link and the transceivers.

30. A method of creating a network comprising:
deploying first and second physically disconnected wired links across a landscape from a moving vehicle, wherein at least two transceivers configured for wired and wireless communication are communicatively coupled along each of the first and second physically disconnected wired links prior to deployment of the wired links;
forming a wireless communication link from one of the at least two transceivers coupled to the first physically disconnected wired link to one of the at least two transceivers coupled to the second physically disconnected wired link; and
determining communication paths between a plurality of devices, wherein the communications paths include the wireless communication link and at least portions of the first and second physically disconnected wired links.
